(19) United States
(12) Patent Application Publication
(10) Pub. No.: US 2018/0338056 A1
(43) Pub. Date: Nov. 22, 2018

(54) Secure Printing Device Controls

(71) Applicant: Bank of America Corporation, Charlotte, NC (US)

(72) Inventor: Manu Jacob Kurian, Dallas, TX (US)

(21) Appl. No.: 15/596,054

(22) Filed: May 16, 2017

(51) Int. Cl. H04N 1/00; G06F 21/60; H04N 1/44; G06K 15/02; G06K 15/00

(52) U.S. Cl. CPC H04N 1/00883; G06F 21/608; H04N 1/00848; H04N 1/446; H04N 2201/0082; G06K 15/021; G06K 15/4095; H04N 2201/0081; H04N 1/448

(57) ABSTRACT

Systems for controlling access to documents including sensitive information and/or sensitive information are provided. In some examples, a system, computing platform, or the like, may receive a command to print a document or generate a photocopy of a document. The computing platform may analyze the document to determine whether the document includes sensitive information. If not, a first ink source, first paper source, first output destination, or the like, may be identified for use in printing the document. If so, a second, different ink source, paper source, and/or output destination may be identified for use in printing the document. The computing platform may then transmit an instruction to the printing, copying, scanning, or the like, device to print the document using the identified ink source, paper source, and/or output destination.

### BACKGROUND

Aspects of the disclosure relate to implementing and using controls to implement secure printing from one or more printing devices, copying devices, or the like.

Maintaining control of sensitive information is an important aspect of many businesses. While controlling distribution of sensitive information in electronic format is often a topic of focus, controlling distribution of the same sensitive information in hard copy form is also important. Many entities permit printing of documents including sensitive information, photocopying of documents with sensitive information, and the like, with few, if any, controls in place to control distribution of the sensitive information, and the like. For instance, documents may be printed for a meeting and distributed to attendees. However, unless the printed documents are retrieved from attendees and destroyed, it may be impossible to control distribution of the sensitive information within the documents.

In another example, printing and/or copying devices often dispense a printed document or generated photocopy to a tray that is accessible to anyone in the area of the printing device or copying device. This may make maintaining control of sensitive information difficult.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, and convenient technical solutions that address and overcome the technical problems associated with maintaining control of sensitive information in hard copy documents.

In some examples, a system, computing platform, or the like, may receive a command to print a document or generate a photocopy of a document. In some examples, the command may be received by the computing platform continuously scanning one or more printing, copying, scanning, or the like, devices. The computing platform may analyze the document to determine whether the document includes sensitive information. If not, a first ink source may be identified for use in printing the document. If so, a second, different ink source may be identified for use in printing the document. The computing platform may then transmit an instruction to the printing, copying, scanning, or the like, device to print the document using the identified ink source.

In some examples, the second ink source used for printing documents containing sensitive information may include ink of a color different from the ink of the first ink source. In other examples, the ink of the second source may be configured to fade or erase a predetermined time after printing the document or generating the photocopy.

In some arrangements, the computing platform may also determine a paper source for use in printing based on the determination of whether the document includes sensitive information. Additionally or alternatively, the computing platform may determine an output destination for a printed document or generated photocopy based on whether the document includes sensitive information.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for implementing and using a system for controlling secure printing, copying and/or scanning of a document, file, or the like, in accordance with one or more aspects described herein;

FIGS. 2A-2C depict an illustrative event sequence for implementing and using a system for controlling secure printing of a document, file or the like, in accordance with one or more aspects described herein;

FIGS. 3A-3C depict an illustrative event sequence for implementing and using a system for controlling secure copying of a document in accordance with one or more aspects described herein;

FIG. 4 depicts an illustrative method for implementing and using a system for controlling secure printing of a document, file, or the like, in accordance with one or more aspects described herein;

FIG. 5 depicts an illustrative method for implementing and using a system for controlling secure photocopying of a document in accordance with one or more aspects described herein;

FIG. 6 depicts an illustrative method for implementing and using a system for providing access to a secure document deposit box in accordance with one or more aspects described herein;

FIG. 7 depicts an illustrative method for implementing and using a system for controlling access to sensitive information in a document in accordance with one or more aspects described herein;

FIG. 8 depicts another illustrative method for implementing and using a system for controlling access to sensitive information in a document in accordance with one or more aspects described herein;

FIG. 9 illustrates one example operating environment in which various aspects of the disclosure may be implemented in accordance with one or more aspects described herein; and

FIG. 10 depicts an illustrative block diagram of workstations and servers that may be used to implement the processes and functions of certain aspects of the present disclosure in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Some aspects of the disclosure relate to controlling access to sensitive information in documents. In some examples, aspects described herein are related to controlling access to sensitive information in a hard copy document, such as a printed document or generated photocopy of a document.

Conventional systems often have limited, if any, controls on documents including sensitive information once a hard copy of the document has been generated. For instance, if a document is printed, or a photocopy of a document is generated, it may be difficult or impossible to control distribution of sensitive information within the document. This may lead to unauthorized users obtaining sensitive information.

Accordingly, aspects described herein are directed to controlling access to sensitive information. For instance, a system may receive a command to print a document or generate a photocopy, such as for distribution during a meeting, or the like. The system may evaluate or analyze the document to determine whether the document includes sensitive information. If not, the document may be printed or the photocopy generated using conventional ink, paper, output trays or other destinations, and the like.

If the document does include sensitive information, the system may identify an alternate source of ink, paper, or output destination, for use in printing the document or generating the photocopy. For instance, the system may identify a source of ink that may fade a predetermined time after printing so as to make the content of the document illegible. In another example, the system may select a paper type configured to obscure the printed text a predetermined time after printing. In another example, the system may identify a secure document deposit box having limited or controlled access as an output destination for the printed document or generated photocopy.

These and various other arrangements will be discussed more fully below.

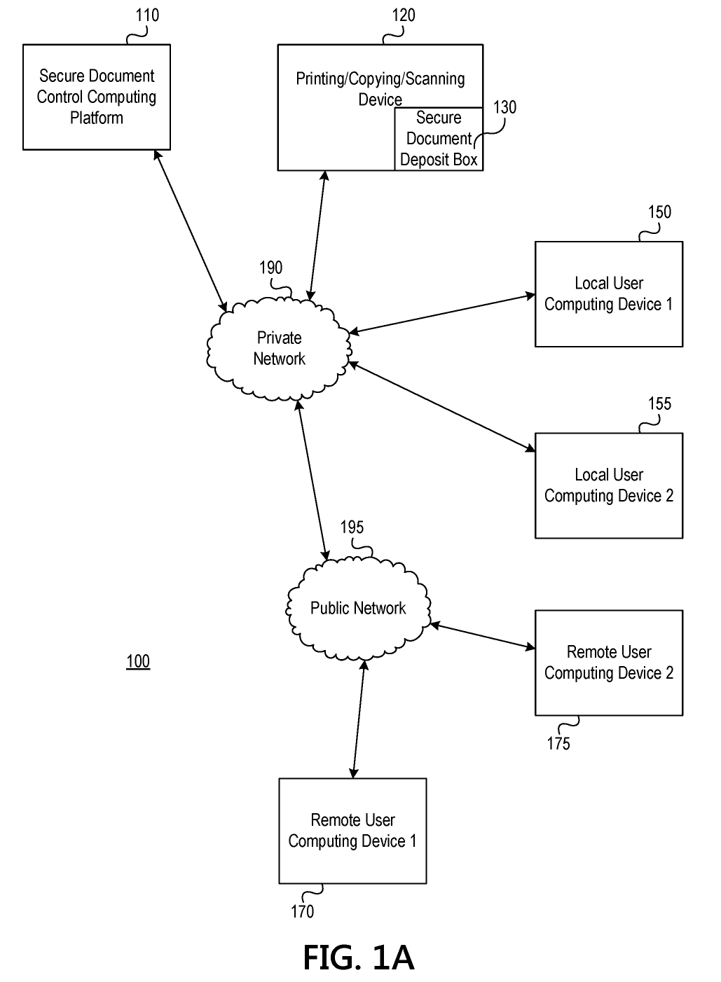

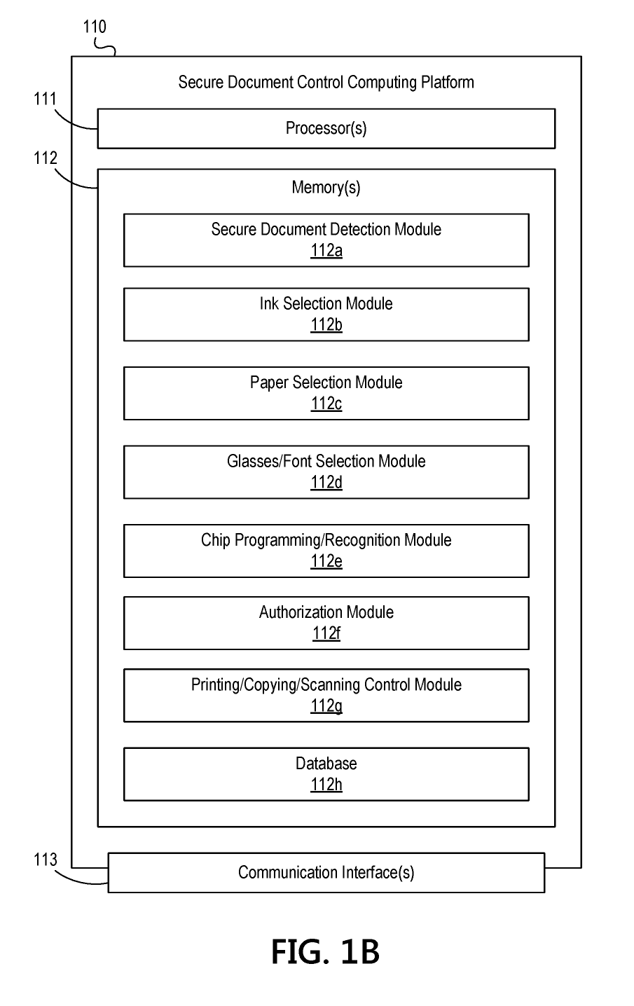

FIGS. 1A and 1B depict an illustrative computing environment for implementing and using a system for controlling secure printing, copying and/or scanning of a document, file, or the like, in accordance with one or more aspects described herein. Referring to FIG. 1A, computing environment 100 may include one or more computing devices and/or other computing systems. For example, computing environment 100 may include a secure document control computing platform 110, a printing/copying/scanning device 120 having a secure document deposit box 130, a first local user computing device 150, a second local user computing device 155, a first remote user computing device 170, and a second remote user computing device 175.

Secure document control computing platform 110 may be configured to host and/or execute various document evaluation, destination determination, ink selection, paper selection, and the like, functions as discussed in greater detail below. In some instances, secure document control computing platform 110 may monitor one or more printing, copying, scanning, or the like, devices, such as printing/copying/scanning device 120, to detect when a file or document is selected for printing, copying or scanning, evaluate content of the document or file to determine whether sensitive or secure information is included, and determine one or more printing, copying and/or scanning parameters or controls based on the analysis, determinations, and the like.

Printing/copying/scanning device 120 may be any time of document generation, production or reproduction device. In some examples, the printing/copying/scanning device 120 may include a computing device controlling one or more aspects of the printing/copying/scanning device 120. In some examples, secure document control computing platform 110 may control one or more aspects of the printing/copying scanning device 120 and/or may transmit one or more commands or instructions to a computing device of the printing/copying/scanning device 120 to control document generation and/or reproduction.

In some examples, printing/copying/scanning device 120 may include a secure document deposit box 130. The secure document deposit box 130 may be a repository into which one or more printed documents, copied documents, scanned documents, or the like, may be distributed upon generation. In some examples, access to the secure document deposit box 130 may be restricted and/or controlled so that only individuals identified as authorized to access one or more documents within the secure document deposit box 130 may be able to access the contents of the secure document deposit box 130. In some examples, access to the secure document deposit box 130 may be controlled via username and password, personal identification number, biometric data such as iris scan, fingerprint, or the like, voice recognition, or the like.

Although printing/copying/scanning device 120 may generally be described herein as include all of these types of functionalities, aspects described herein may be implemented using devices configured for just a single functionality, or two of three functionalities, or additional functionalities, without departing from the invention. For instance, aspects described herein may be used with devices configured to provide only printing functions, only copying and printing functions, or the like.

Local user computing device 150, 155 and remote user computing device 170, 175 may be configured to communicate with and/or connect to one or more computing devices or systems shown in FIG. 1A. For instance, local user computing device 150, 155 may communicate with one or more computing systems or devices via network 190, while remote user computing device 170, 175 may communicate with one or more computing systems or devices via network 195. The local and remote user computing devices may be used to provide access one or more systems or computing devices, to request generation or printing of a document, display one or more notifications, and the like, as will be discussed more fully below.

In one or more arrangements, local user computing device 150, local user computing device 155, remote user computing device 170, and remote user computing device 175 may be any type of computing device capable of performing the particular functions described herein. For example, local user computing device 150, local user computing device 155, remote user computing device 170, and remote user computing device 175 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of local user computing device 150, local user computing device 155, remote user computing device 170, and remote user computing device 175 may, in some instances, be special-purpose computing devices configured to perform specific functions.

Computing environment 100 also may include one or more computing platforms. For example, and as noted above, computing environment 100 may include secure document control computing platform 110. As illustrated in greater detail below, secure document control computing platform 110 may include one or more computing devices configured to perform one or more of the functions described herein. For example, secure document control computing platform 110 may include one or more computers (e.g., laptop computers, desktop computers, servers, server blades, or the like).

As mentioned above, computing environment 100 also may include one or more networks, which may interconnect one or more of secure document control computing platform 110, printing/copying/scanning device 120, local user computing device 150, local user computing device 155, remote user computing device 170, and remote user computing device 175. For example, computing environment 100 may include private network 190 and public network 195. Private network 190 and/or public network 195 may include one or more sub-networks (e.g., Local Area Networks (LANs), Wide Area Networks (WANs), or the like). Private network 190 may be associated with a particular organization (e.g., a corporation, financial institution, educational institution, governmental institution, or the like) and may interconnect one or more computing devices associated with the organization. For example, secure document control computing platform 110, printing/copying/scanning device 120, local user computing device 150, and local user computing device 155 may be associated with an organization (e.g., a financial institution), and private network 190 may be associated with and/or operated by the organization, and may include one or more networks (e.g., LANs, WANs, virtual private networks (VPNs), or the like) that interconnect secure document control computing platform 110, printing/copying/scanning device 120, local user computing device 150, and local user computing device 155 and one or more other computing devices and/or computer systems that are used by, operated by, and/or otherwise associated with the organization. Public network 195 may connect private network 190 and/or one or more computing devices connected thereto (e.g., secure document control computing platform 110, printing/copying/scanning device 120, local user computing device 150, and/or local user computing device 155) with one or more networks and/or computing devices that are not associated with the organization. For example, remote user computing device 170 and remote user computing device 175 might not be associated with an organization that operates private network 190 (e.g., because remote user computing device 170 and remote user computing device 175 may be owned, operated, and/or serviced by one or more entities different from the organization that operates private network 190, such as one or more customers of the organization and/or vendors of the organization, rather than being owned and/or operated by the organization itself or an employee or affiliate of the organization), and public network 195 may include one or more networks (e.g., the internet) that connect remote user computing device 170 and remote user computing device 175 to private network 190 and/or one or more computing devices connected thereto (e.g., secure document control computing platform 110, printing/copying/scanning device 120 local user computing device 150, and/or local user computing device 155).

Referring to FIG. 1B, secure document control computing platform 110 may include one or more processors 111, memory 112, and communication interface 113. A data bus may interconnect processor(s) 111, memory 112, and communication interface 113. Communication interface 113 may be a network interface configured to support communication between secure document control computing platform 110 and one or more networks (e.g., private network 190, public network 195, or the like). Memory 112 may include one or more program modules having instructions that when executed by processor(s) 111 cause secure document control computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of secure document control computing platform 110 and/or by different computing devices that may form and/or otherwise make up secure document control computing platform 110.

For example, memory 112 may have, store, and/or include a secure document detection module 112a. The secure document detection module 112a may store instructions and/or data that may cause or enable the secure document control computing platform 110 to analyze content associated with one or more documents, files, or the like, for which a generation or reproduction process (e.g., printing, copying, scanning, or the like) is requested. In some examples, analyzing the content may include using processes such as optical character recognition to decipher the content of the document. In analyzing the content, the secure document detection module 112a may evaluate content to determine whether one or more types of content are present in the document, file, or the like. For instance, the secure document detection module 112a may determine whether types of data such as account numbers, unique identifiers of a user, customer or client name, customer or client address or other contract information, and the like, is present in the document or file. If so, the secure document detection module 112a may determine that sensitive or secure information is present in the document or file and may cause additional security measures to be implemented.

In some examples, the secure document detection module 112a may analyze the content to identify patterns, sequences, or combinations of words, character strings, or the like. For instance, the secure document detection module 112a may include instructions to analyze a document to determine whether a 16 digit string of numbers with spaces after each fourth number is present in the document. This may indicate the presence of a credit card number in the document. Various other patterns, sequences, or combinations may be evaluated without departing from the invention.

Additionally or alternatively, the document being printed or photocopied may include an indication that sensitive material is contained therein. For instance, a particular letterhead may be used to indicate content that is sensitive. In another example, a cipher or character may be included in each document having sensitive information which may then be read and deciphered by the secure document detection module 112a.

In some examples, different types of sensitive data may be associated with different levels of security. For instance, content such as a phone number or address of a user may be considered sensitive but less sensitive than, for example, an account number or unique identifier of a user. Accordingly, a first set of secure document controls may be implemented for documents or files having phone number or address content (e.g., dispense print to a secure location, require additional authentication or authorization to print, or the like), while a second set of secure document controls may be implemented for documents having account number or unique identifier content (e.g., use of particular types of ink that may dissolve after a predetermined time period, use of paper that may deteriorate after a predetermined time period, or the like). In some examples, the second set of secure document controls may include one or more control from the first set of document controls. In other examples, the second set of document controls may be different from the first set of document controls. The sets of controls may further include different types of ink, paper, or the like, that may dissolve over longer, or shorter, time periods, as desired.

Memory 112 may further have, store and/or include an ink selection module 112b. For instance, the ink selection module 112b may store instructions and/or data that may cause or enable the secure document control computing platform 110 to select an ink source based on the determination by the secure document detection module 112a of whether sensitive information or content is present. For instance, printing/copying/scanning device 120 may include one or more sources of ink, toner, or the like, to print a document, generate a copy of a document, or the like. The sources may, in some examples, include different types of ink. For instance, the sources may include a conventional or standard ink or toner that may be used to print documents identified as not including sensitive information. In another example, the printing/copying/scanning device 120 may include an ink source including a type of ink configured to dissolve (e.g., “disappear”) after a predetermined amount of time. For instance, a migrating ink may be used in conjunction with two part paper that slowly absorbs the migrating ink over time to cause the content of the document to “disappear.” In another example, the printing/copying/scanning device may include a source of nanoparticle ink (e.g., nanoparticles embedded in organic gel film) that may be configured to fade away after a predetermined amount of time.

In some examples, the ink may be of a type that reacts with air. Accordingly, when in an ink cartridge, the ink may be dormant. However, upon a document being printed with the ink or a copy generated with the ink, air may contact the ink, thereby causing it to slowly dissolve over a period of time. In another example, contact with paper, or particular types of paper, may cause the ink to slowly dissolve, thereby causing the content of the document to disappear after a period of time. Various other disappearing inks may be used without departing from the invention. In another example, invisible ink may be used to print the document and an authorized user may apply heat, view the document using an ultraviolet light, or the like, to view the print.

In other examples, selection of the ink source may include selection of a source of ink having a particular color. For example, documents identified as including sensitive information may be printed or generated using red ink (or another particular color) to quickly identify a document as including sensitive information and to ensure that documents including sensitive information are promptly and properly disposed of.

Memory 112 may further have, store and/or include paper selection module 112c. Paper selection module 112c may have or store instructions and/or data configured to cause the secure document control computing platform 110 to determine a paper source within the printing/copying/scanning device 120 to be used to generate a document based on whether the document includes sensitive information. For instance, printing/copying/scanning device 120 may include one or more sources of paper on which to print a document, generate a copy of a document, or the like. Based on the determination of whether the document includes sensitive information, the paper selection module 112c may identify a source of paper on which to print or generate the document. In some examples, if sensitive information is present in the document, paper configured to fade over time, two-part paper and migrating ink combinations may be used to obscure the data after a predetermined time period, or the like, may be selected to generate a document. The document may then become unreadable after a predetermined time period, thereby protecting the sensitive information. In another example, paper that is water-soluble may be used such that, after reading the document, a user may dissolve the paper in water (or other dissolving solution) to avoid distribution of the sensitive information contained in the document. In another example, paper may be printed with invisible ink that is visible when heat is applied, when viewed with an ultraviolet light, or the like. In still other examples, one or more solutions may be used to treat the paper to obscure the text, enable limited viewing of the text, and the like.

Memory 112 may further have, store and/or include a glasses/font selection module 112d. The glasses/font selection module 112d may have and/or store instructions and/or data configured to cause or enable secure document computing platform 110 to identify a recipient or person associated with the document and generate the document for use with a particular reading device, such as a pair of glasses. For instance, a customer, when registering with a system, may be given a particular pair of glasses which may then be used to read documents related to their accounts, or the like. The documents may be generated in a particular font legible only when viewed through the glasses of the customer, using an ink visible only through the glasses of the customer, or the like. For instance, the glasses may be configured to refract light in a particular way to decode the document for the user.

Memory 112 may further have, store, and/or include chip programming/recognition module 112e. Chip programming/recognition module 112e may have or include instructions and/or data configured to cause or enable secure document control computing platform 110 to generate a document using paper having a chip or other electronic device embedded therein. The chip programming/recognition module 112e may identify a recipient or other user of the document and may transmit user identifying information to the electronic device embedded in the paper (e.g., fingerprint data, or the like). The document may then be generated and, upon receiving the document, the user may contact a portion of the document (e.g., a predetermined region) in which the chip is located to detect the fingerprint or other information of the user. If the information is a match, the document may be maintained. If the information is not a match, the ink may be caused to disappear after a predetermined time (e.g., as indicated above) or the paper may be caused to disintegrate. In another example, the chip may detect, for example, biometric data of a user, and may transmit the data to a central source (e.g., the secure document control computing platform) for authorization. The system may then record whether the user is an authorized user in order to track users who have accessed a particular document.

In some examples, paper used to print the document may include a plurality of sensors. For example, the paper may be lined with sensors forming a grid pattern. The sensors may be configured to detect or read biometric data from a user, such as a fingerprint, upon contact with the paper. The detected fingerprint may, in some examples, be transmitted to an authenticating system, such as secure document control computing platform 110, to determine whether the detected data matches data of an authorized user. If so, the document may remain in tact with the text and other content visible. If not, an ink reaction may be initiated to scramble the text appearing on the document. In another example, if ink is printed in tokenized form, the text would not be de-tokenized if a match does not exist. In yet another example, a determination that a fingerprint does not match and authorized user may cause the paper to shred along grid lines formed by the sensors in the document. The shredding may be cross-cut, micro-cut, or the like.

Memory 112 may further have, store, and/or include authorization module 112f. Authorization module 112f may have or store instructions and/or data to enable or cause the secure document control computing platform 110 to identify whether a document will be dispensed to a secure document deposit box and to determine whether a user is authorized to access the secure document deposit box. For instance, a printing/copying/scanning device 120 may include, in addition to or in lieu of a standard tray on which to dispense printed or copied documents, a secure deposit box into which one or more documents including sensitive information may be dispensed. The secure deposit box 130 may be connected to the printing/copying/scanning device 120 and may include one or more controls to permit access to only authorized users. For instance, access to the secure deposit box 130 may be via username and password, personal identification number, fingerprint, iris scan, voice recognition, other biometric information, or the like.

In some examples, based on a type or o amount of sensitive data detected within a document or file, the authorization module 112f may determine whether the document will be dispensed to the standard tray or to the secure document deposit box 130. If to the secure document deposit box, the authorization module 112f may identify a user associated with the requested print or copy and may retrieve authentication information associated with the user. For instance, the authorization module 112f may query database 112h to retrieve authenticating information associated with the user. Upon arriving to pick up a print or copy, the user may be prompted to input his or her authenticating information, which may then be transmitted to the authorization module 112f to determine whether a match exists between the received information and the information retrieved from the database 112h. If the data does not match, the user will be denied access to the secure document deposit box 130 and contents therein. If the data does match, the user may be granted access to the secure document deposit box 130 and contents thereof.

Memory 112 may further have, store, and/include printing/copying/scanning control module 112g. Printing/copying/scanning control module 112g may have or include instructions and/or data to enable or cause the secure document computing platform 110 to control one or more aspects of printing, copying, and/or scanning a document. For instance, the printing/copying/scanning control module 112g may transmit one or more instructions or commands to printing/copying/scanning device 120 to control an ink source, a paper source, a deposit destination, or the like, based on the analysis of the document, determinations made by one or more modules, and the like. The printing/copying/scanning control module 112g may then cause the document to be printed, generated, or the like, according to the criteria, features, parameters, or the like, identified to aid in protecting the sensitive information identified in the document.

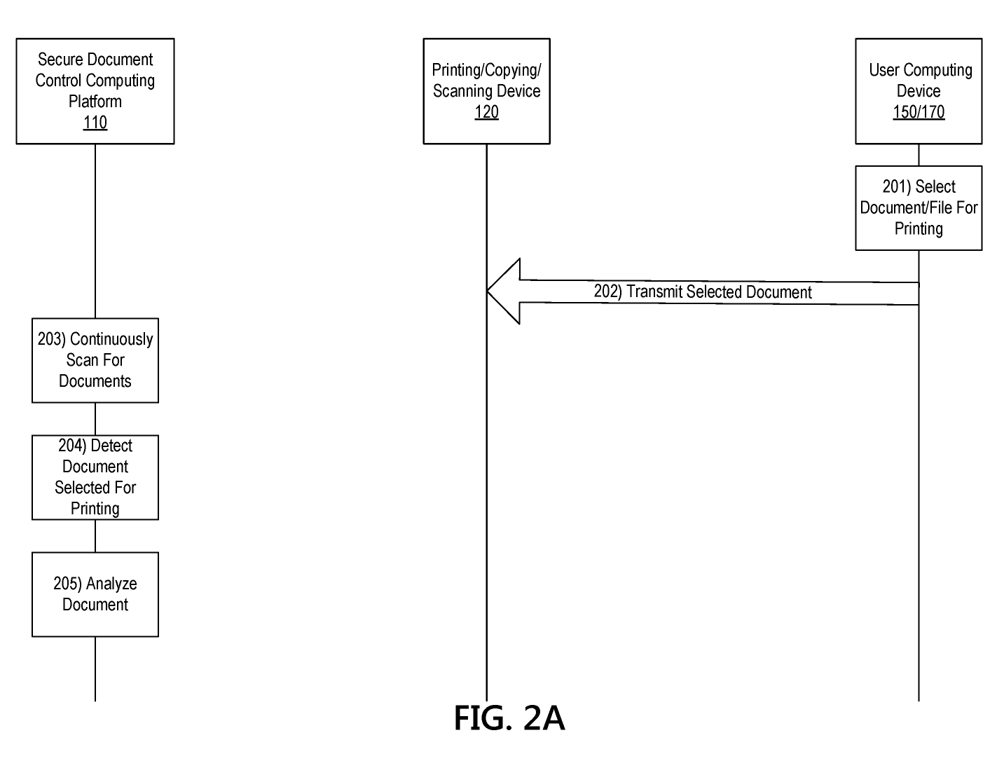

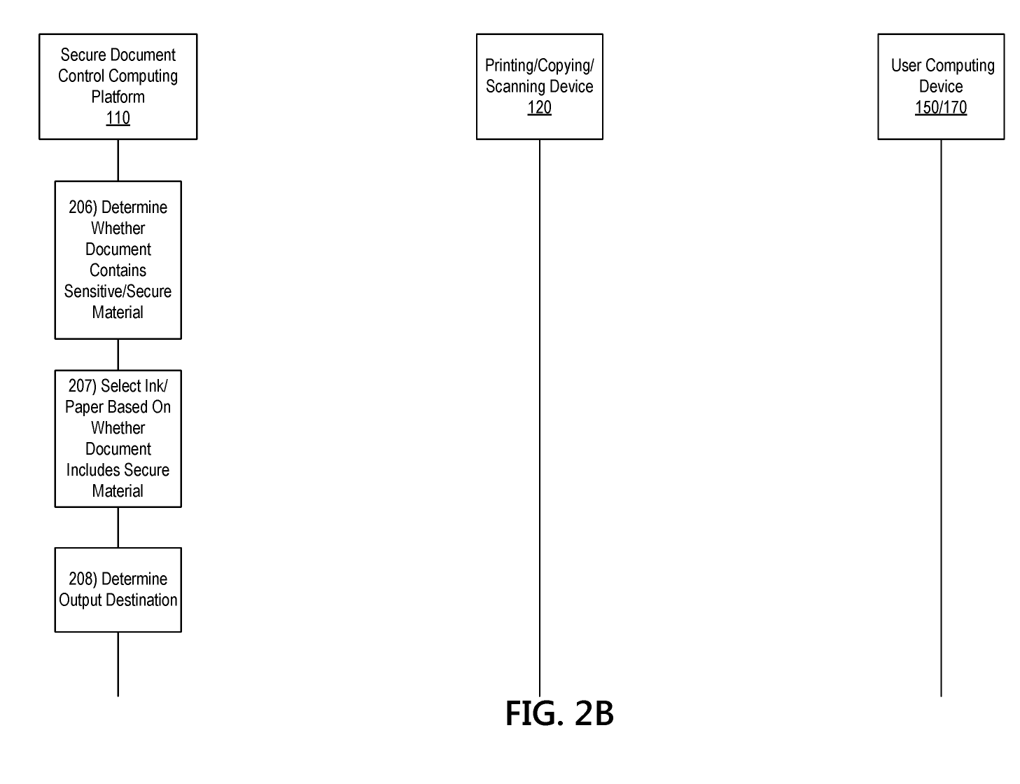

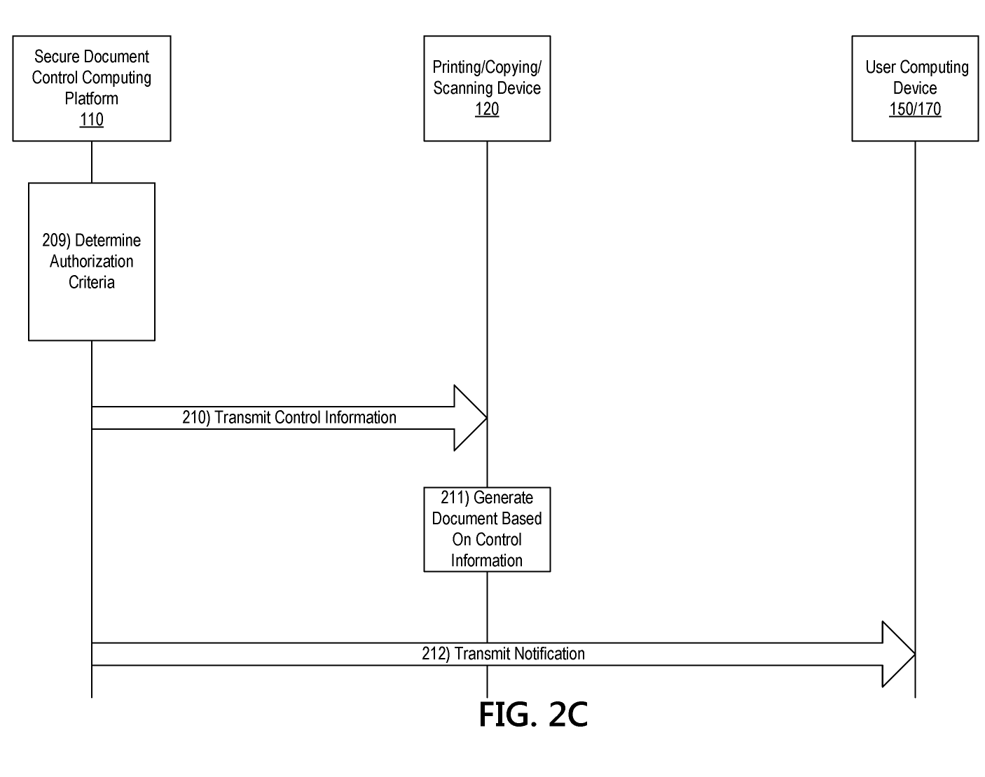

FIGS. 2A-2C depict an illustrative event sequence for implementing and using secure printing device controls in accordance with one or more aspects described herein. The events shown in the illustrative event sequence are merely one example sequence and additional events may be added, or events may be omitted, without departing from the invention.

Referring to FIG. 2A, at step 201, a document or file may be selected for, for example, printing. Similar arrangements for copying, scanning, or the like may be performed as well using the arrangements of FIGS. 2A-2C as well as other aspects described herein.

In some examples, the file or document may be selected via a user computing device, such as local user computing device 150, 155 or remote user computing device 170, 175. The document or file may be in one of various formats, generated via one or more different applications, or the like, without departing from the invention.

In step 202, the selected document or file may be transmitted to printing/copying/scanning device 120 for printing. The document or file may be transmitted via a network after establishing a network connection between, for example, the printing/copying/scanning device 120 be in communication with or connected to local user computing device 150, 155, remote user computing device 170, 175, and/or secure document control computing platform 110 via a network and associated network connection established to enable communication between the devices.

At step 203, the secure document control computing platform 110 may continuously scan one or more printing/copying/scanning devices, such as device 120 to detect a document or file transmitted for printing, copying, scanning, or the like. In step 204, the selected document may be detected by the secure document control computing platform 110. In some examples, detection of the document may activate or enable secure document control functionalities of the secure document control computing platform 110.

At step 205, the secure document control computing platform 110 may analyze the detected document to determine whether the detected document includes sensitive or secure information or data (e.g., data that should be protected). For instance, the secure document control computing platform 110 may analyze the document to determine whether it includes data such as personal identifying information of a customer or user, contact information of a customer or user, account number of a customer or user, payment device number of a customer or user, medical or health care information of a customer or user, and the like. The analysis may be performed in real-time.

With reference to FIG. 2B, at step 206, the secure document control computing platform 110 may determine whether the document includes sensitive information. If not, the secure document control computing platform 110 may transmit an instruction, signal or command to printing/copying/scanning device 120 to print the selected document. If the document does include sensitive information, the secure document control computing platform 110 may select one or more of: an ink source and a paper source in step 207. For instance, as discussed above, a source of ink having properties that enable it to fade or “disappear” after a predetermined amount of time (or fade over a predetermined amount of time) may be selected. In another example, a source of ink having a particular color may be selected. In yet another example, a source of paper that will cause the content of the document to fade or be obscured after a predetermined amount of time may be selected. Various other ink and/or paper options may be selected without departing from the invention.

In step 208, an output or dispensing destination may be selected. For instance, in some examples, a printed document may be dispensed to a tray that is accessible to anyone near the printing device 120. In other examples, the printed document may be output or dispensed to a secure document deposit box, access to which is controlled such that only authorized users may access the deposit box and contents thereof.

With reference to FIG. 2C, at step 209, one or more authorization criteria to access the secure document deposit box may be determined for situations in which the document will be dispensed to the secure document deposit box. For instance, the secure document control computing platform 110 may identify the user requesting the printed document and may retrieve authentication information associated with the user. Accordingly, upon receiving authentication information from the user (e.g., input at the secure document deposit box) the secure document control computing platform 110 may determine whether the credentials match and either permit or deny access to the contents of the secure document deposit box.

At step 210, control information for printing the selected document or file may be transmitted to the printing/copying/scanning device 120. For instance, the selected ink and/or paper source, output destination, and the like, may be transmitted to the printing/copying/scanning device 120. The control information may further include a signal, instruction or command to print or generate the requested document. In step 211, the document may be printed or generated according to the control information. In step 212, a notification may be transmitted to a user computing device 150, 170, indicating that the document or file has been printed. In some examples, the notification may include an indication of the controls implemented in printing the document or file, an indication that the document or file includes sensitive information, and the like.

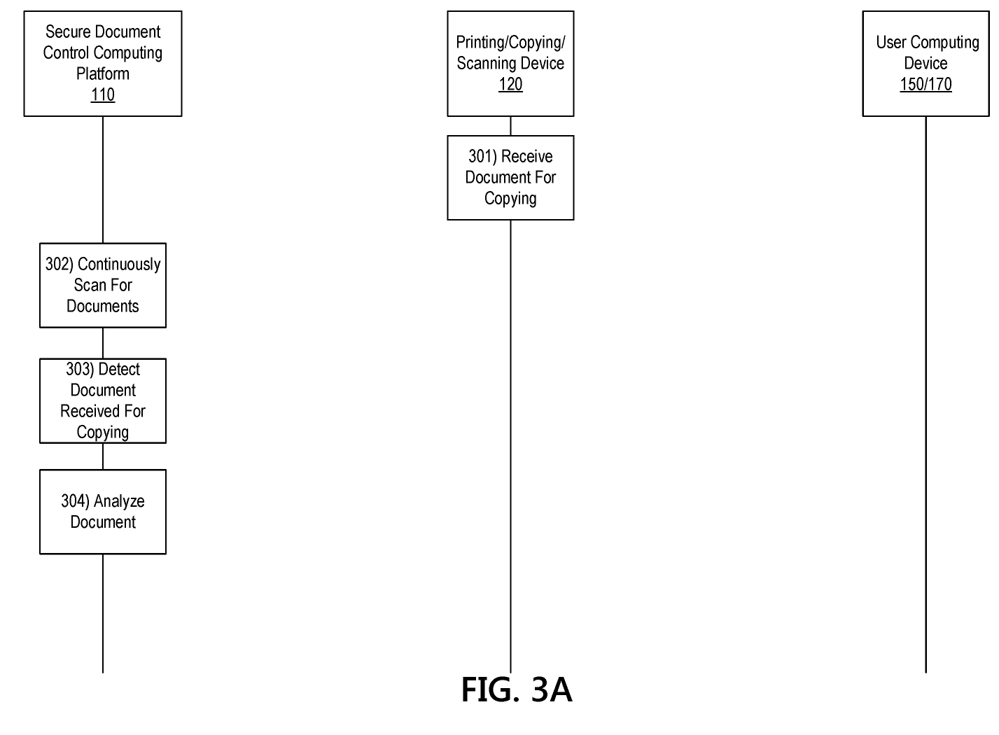

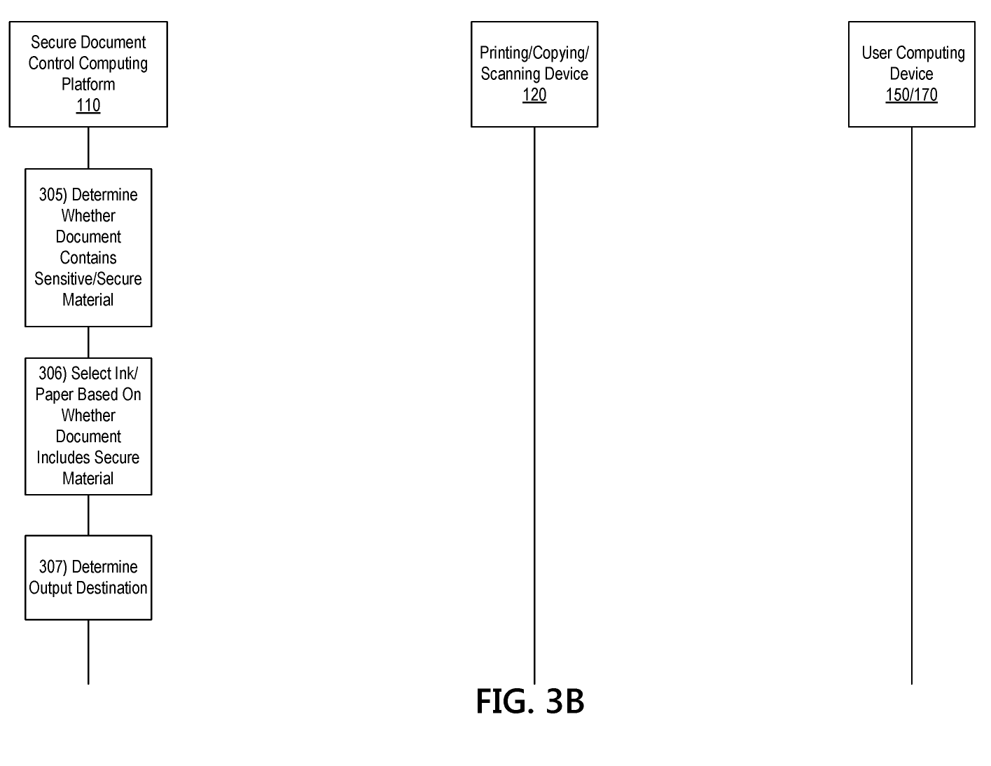

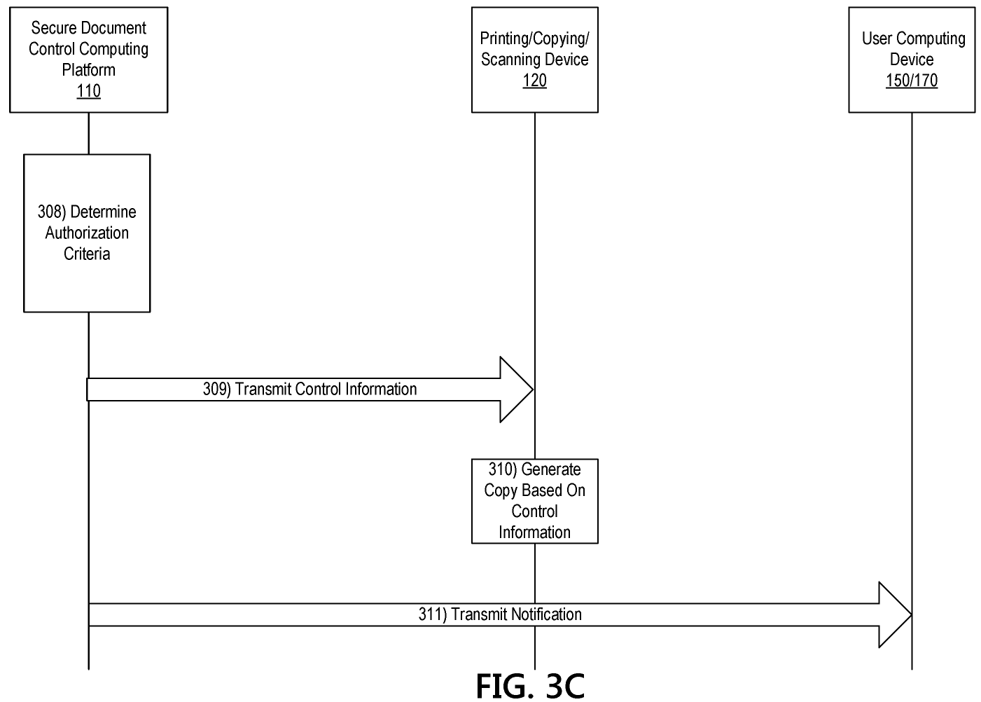

FIGS. 3A-3C depict an illustrative event sequence for implementing and using secure copying device controls in accordance with one or more aspects described herein. The events shown in the illustrative event sequence are merely one example sequence and additional events may be added, or events may be omitted, without departing from the invention.

Referring to FIG. 3A, at step 301, a document or file may be selected for, for example, copying. Similar arrangements for printing, scanning, or the like may be performed as well using the arrangements of FIGS. 3A-3C as well as other aspects described herein. The selected document may be received at the printing/copying/scanning device 120.

At step 302, the secure document control computing platform 110 may continuously scan one or more printing/copying/scanning devices, such as device 120 to detect a document or file received by the printing/copying/scanning device for copying, or the like. In step 303, the selected document received for copying may be detected by the secure document control computing platform 110. In some examples, detection of the document may activate or enable secure document control functionalities of the secure document control computing platform 110.

At step 304, the secure document control computing platform 110 may analyze the detected document to determine whether the detected document includes sensitive or secure information or data (e.g., data that should be protected). For instance, the secure document control computing platform 110 may analyze the document to determine whether it includes data such as personal identifying information of a customer or user, contact information of a customer or user, account number of a customer or user, payment device number of a customer or user, medical or health care information of a customer or user, and the like. The analysis may be performed in real-time. In some examples, processes such as optical character recognition may be used to determine whether the document contains sensitive information.

With reference to FIG. 3B, at step 305, the secure document control computing platform 110 may determine whether the document includes sensitive information. If not, the secure document control computing platform 110 may transmit an instruction, signal or command to printing/copying/scanning device 120 to proceed with copying the selected document. If the document does include sensitive information, the secure document control computing platform 110 may select one or more of: an ink source and a paper source in step 306. For instance, as discussed above, a source of ink having properties that enable it to fade or “disappear” after a predetermined amount of time may be selected. In another example, a source of ink having a particular color may be selected. In yet another example, a source of paper that will cause the content of the document to fade or be obscured after a predetermined amount of time may be selected. Various other ink and/or paper options may be selected without departing from the invention.

In step 307, an output or dispensing destination may be selected. For instance, in some examples, a generated copy of a document may be dispensed to a tray that is accessible to anyone near the printing device 120. In other examples, the generated copy of the document may be output or dispensed to a secure document deposit box, access to which is controlled such that only authorized users may access the deposit box and contents thereof.

With reference to FIG. 3C, at step 308, one or more authorization criteria to access the secure document deposit box may be determined for situations in which the generated copy of the document will be dispensed to the secure document deposit box. For instance, the secure document control computing platform 110 may identify the user requesting the generated copy of the document and may retrieve authentication information associated with the user. Accordingly, upon receiving authentication information from the user (e.g., input at the secure document deposit box) the secure document control computing platform 110 may determine whether the credentials match and either permit or deny access to the contents of the secure document deposit box.

At step 309, control information for copying the received document may be transmitted to the printing/copying/scanning device 120. For instance, the selected ink and/or paper source, output destination, and the like, may be transmitted to the printing/copying/scanning device 120. The control information may further include a signal, instruction or command to generate the requested copy of the document. In step 310, the copy of the document may be generated according to the control information. In step 311, a notification may be transmitted to a user computing device 150, 170, indicating that the copy of the document has been generated. In some examples, the notification may include an indication of the controls implemented in generating the copy, an indication that the document or file includes sensitive information, and the like.

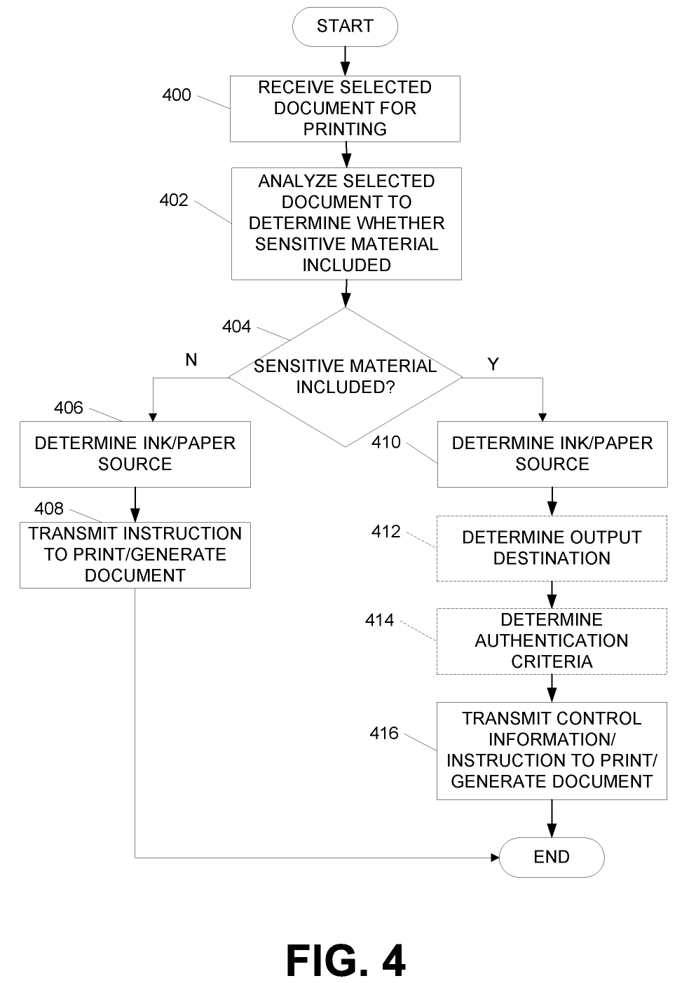

FIG. 4 is a flow chart illustrating one example method of controlling printers, copiers, scanners, and the like for generating secure documents in accordance with one or more aspects described herein. In step 400, a document or file selected for printing may be received. In step 402, the document may be analyzed to determine whether it includes sensitive material or other data that should be protected from broad distribution.

In step 404, a determination may be made, based on the analysis of the document, as to whether the document includes sensitive information. If not, one or more of: an ink source (such as a first ink source of a plurality of ink sources in a printing, copying, and/or scanning device) and/or a paper source (such as a first paper source of a plurality of paper sources in a printing, copying, and/or scanning device) may be determined or identified for use in printing the document in step 406. In step 408, an instruction, signal or command may be transmitted to the printing, copying, and/or scanning device to print the document using the selected one or more of an ink source (e.g., the first ink source) and/or a paper source (e.g., the first paper source).

If, in step 404, the document does include sensitive information, at step 410, one or more of: an ink source (e.g., a second ink source of a plurality of ink sources in the printing, copying, and/or scanning device, the second ink source being different from the first ink source) and/or a paper source (e.g., a second paper source of a plurality of paper sources in the printing, copying, and/or scanning device, the second paper source being different from the first paper source) for printing the document may be determined or identified.

In optional step 412, an output or dispensing destination may be selected. For instance, the system may determine that a conventional output tray is acceptable for output of the printed document. In another example, the system may determine that, due to an amount, type, or the like, of sensitive information in the document, the document will be output to a secure document deposit box having controlled access.

In optional step 414, authentication criteria for accessing the secure document deposit box may be determined. For instance, the system may identify a user requesting to print the document and may retrieve (e.g., from a database) authentication information associated with the user. This information may then be compared to received credentials in order to permit or deny access to the secure document deposit box.

In step 416, the control information (e.g., ink source, paper source, output destination, and the like) may be transmitted to a printing, copying, and/or scanning device. The control information may include a signal, instruction or command to print the document according to the control information provided.

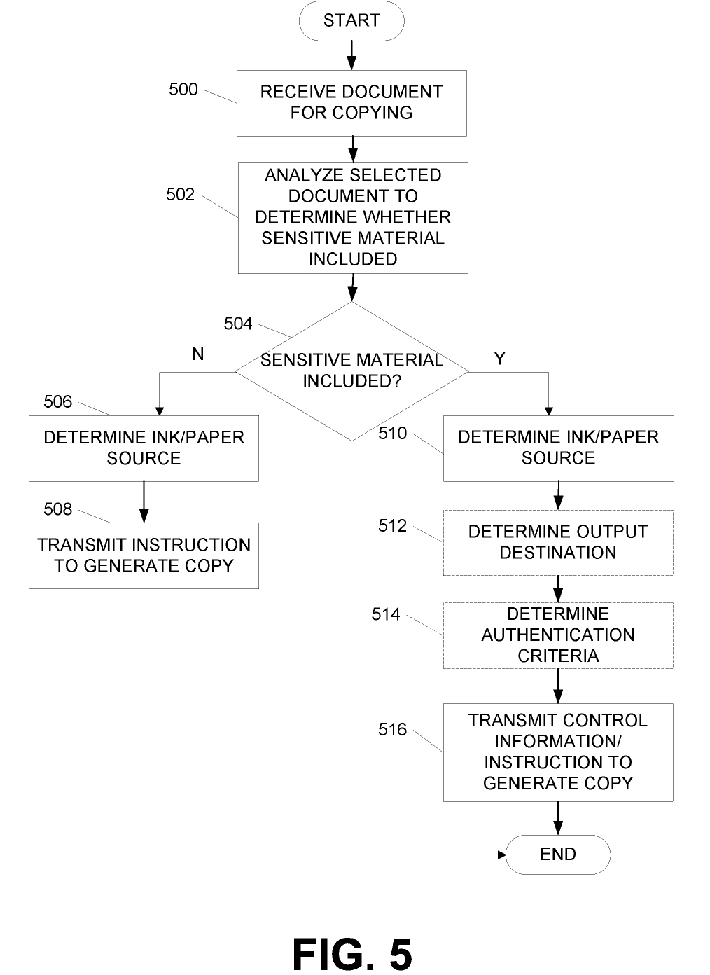

FIG. 5 illustrates one example method of securely generating a copy of a document in accordance with one or more aspects described herein. In step 500, a document to be copied (e.g., photocopied via a copying device) may be received. In step 502, the document may be analyzed to determine whether it includes sensitive material or other data that should be protected from broad distribution. In some examples, analyzing the document may include capturing a scan of the document and analyzing, by the secure document control computing platform 110 the document. In some arrangements, analyzing the document may include using optical character recognition to analyze the document to determine whether sensitive information exists.

In step 504, a determination may be made, based on the analysis of the document, as to whether the document includes sensitive information. If not, one or more of: an ink source (such as a first ink source of a plurality of ink sources in a printing, copying, and/or scanning device) and/or a paper source (such as a first paper source of a plurality of paper sources in a printing, copying, and/or scanning device) may be determined or identified for use in generating the copy of the document in step 506. In step 508, an instruction, signal or command may be transmitted to the printing, copying, and/or scanning device to generate the copy of the document using the selected one or more of an ink source (e.g., the first ink source) and/or a paper source (e.g., the first paper source).

If, in step 504, the document does include sensitive information, at step 510, one or more of: an ink source (e.g., a second ink source of a plurality of ink sources in the printing, copying, and/or scanning device, the second ink source being different from the first ink source) and/or a paper source (e.g., a second paper source of a plurality of paper sources in the printing, copying, and/or scanning device, the second paper source being different from the first paper source) for generating the copy of the document may be determined or identified.

In optional step 512, an output or dispensing destination may be selected. For instance, the system may determine that a conventional output tray is acceptable for output of the generated copy of the document. In another example, the system may determine that, due to an amount, type, or the like, of sensitive information in the document, the generated copy of the document will be output to a secure document deposit box having controlled access.

In optional step 514, authentication criteria for accessing the secure document deposit box may be determined. For instance, the system may identify (e.g., via, for example, a code unique to the user and entered into the printing, copying, and/or scanning device to enable functionality of the device) a user requesting to generate the copy of the document and may retrieve (e.g., from a database) authentication information associated with the user. This information may then be compared to received credentials in order to permit or deny access to the secure document deposit box.

In step 516, the control information (e.g., ink source, paper source, output destination, and the like) may be transmitted to a printing, copying, and/or scanning device. The control information may include a signal, instruction or command to generate the copy of the document according to the control information provided.

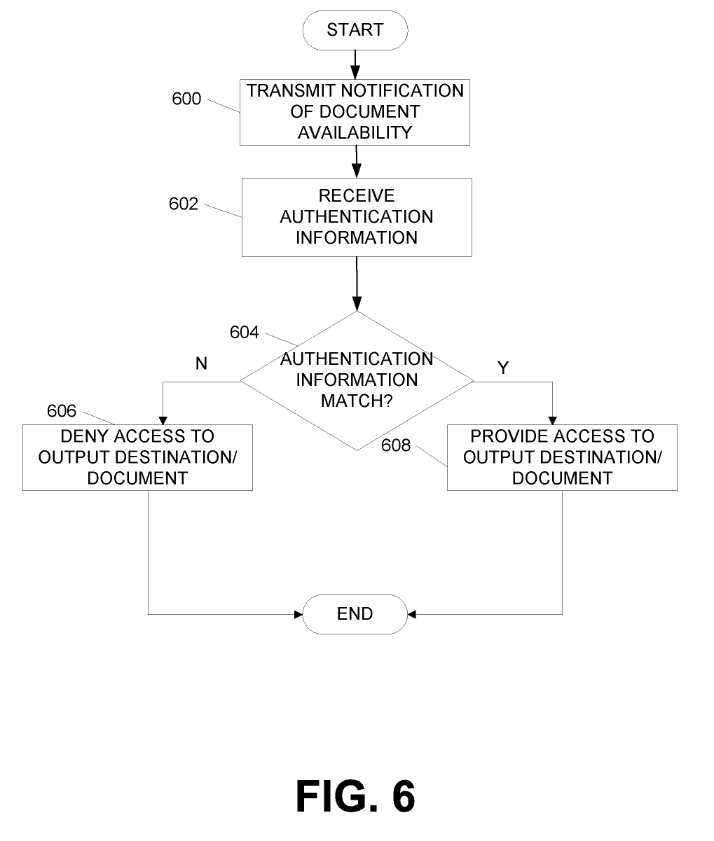

FIG. 6 illustrates one example illustrative method of providing access to a secure document deposit box in accordance with one or more aspects of the invention. For instance, if the system determines that a printed document or copy of a document will be dispensed to a secure document deposit box (e.g., rather than a conventional tray), access to the secure document deposit box may be permitted or denied based on authentication credentials of a user. As discussed above, if a document is dispensed to the secure document deposit box, authentication criteria (e.g., credentials of a user identified as requesting the document, or the like) may be retrieved from a database. In step 600, a notification may be transmitted to a user requesting a print or copy that the document has been generated and is being held in the secure document deposit box.

In step 602, authentication information may be received from the user. For instance, the user may input information to a device associated with the secure document deposit box (or the secure document control computing platform 110) such as a username and password, personal identification number, biometric data, or the like. The system may process this information and, in step 604, may determine whether it matches authentication information retrieved from the database. If a match exists, access to the secure document deposit box and associated contents may be provided in step 608. If not, access may be denied in step 610.

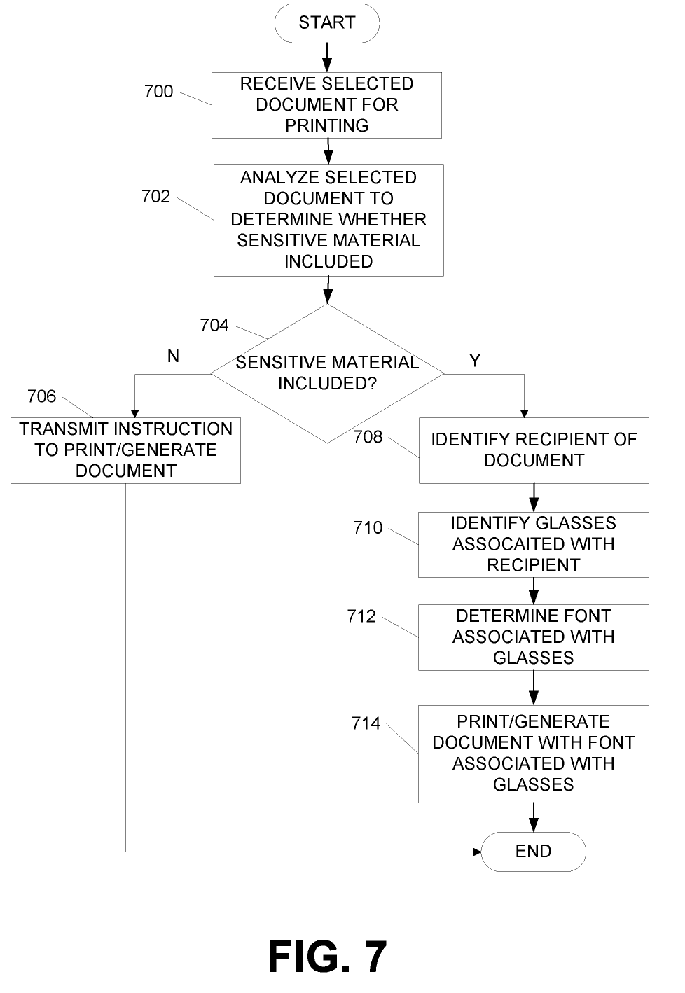

FIG. 7 illustrates one example method of controlling distribution of sensitive information in a document in accordance with one or more aspects described herein. In step 700, a document or file selected for printing may be received. In step 702, the document may be analyzed to determine whether it includes sensitive material or other data that should be protected from broad distribution.

In step 704, a determination may be made, based on the analysis of the document, as to whether the document includes sensitive information. If not, an instruction, command or signal may be transmitted to a printing device to generate or print the document in step 706.

If, in step 704, the document does include sensitive information, at step 708 a recipient of the document may be determined or identified. For example, if the document is a statement of an account of a customer, the customer may be identified (e.g., from data in the document). A type of glasses provided to the identified customer may be retrieve (e.g., from a database storing the information generated, for example, upon opening an account or registering with the system) may be determined in step 710.

In step 712, a font made legible by the glasses identified in step 710 may be identified and, in step 714, an instruction, command or signal may be transmitted to the printing device to generate or print the requested document using the identified font made legible by the glasses associated with the user. Accordingly, should the document fall into the hands of an unauthorized user, the unauthorized user would not be able to read the document without the identified glasses (e.g., the font is only legible through the glasses associated with that font).

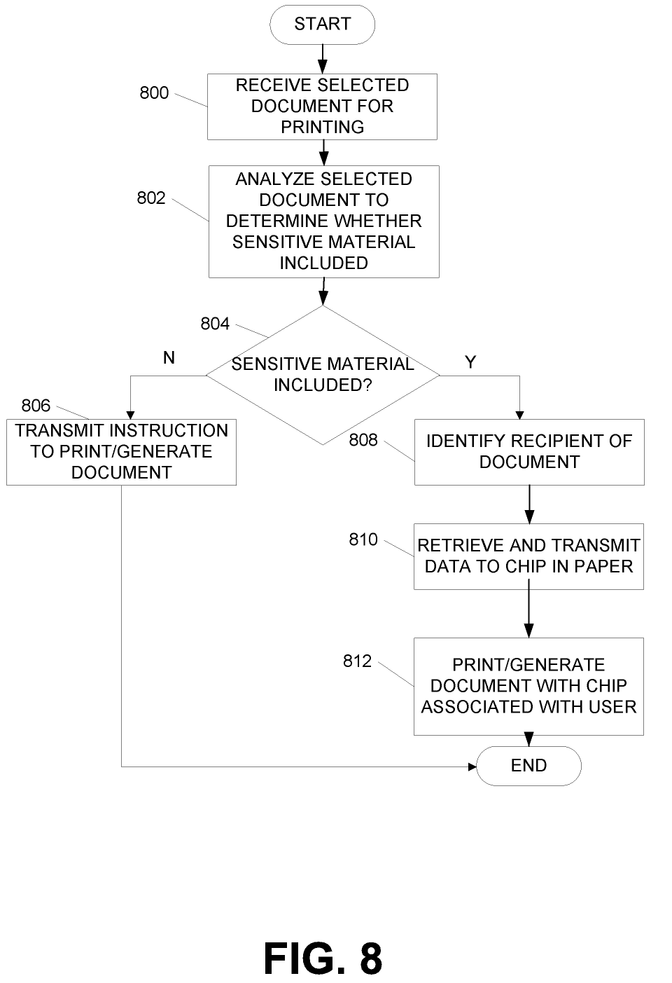

FIG. 8 illustrates another example method of controlling distribution of sensitive information in a document in accordance with one or more aspects described herein. In step 800, a document or file selected for printing may be received. In step 802, the document may be analyzed to determine whether it includes sensitive material or other data that should be protected from broad distribution.

In step 804, a determination may be made, based on the analysis of the document, as to whether the document includes sensitive information. If not, an instruction, command or signal may be transmitted to a printing device to generate or print the document in step 806.

If, in step 804, the document does include sensitive information, at step 808 a recipient of the document may be determined or identified. For example, if the document is a statement of an account of a customer, the customer may be identified (e.g., from data in the document). In step 810, data associated with the identified recipient may be retrieved, e.g., from a database. For example, biometric data such as a fingerprint may be retrieved and transmitted to a chip or other electronic device embedded in the document. In step 812, the system may then transmit an instruction, command or signal to generate or print the document on paper having the retrieved data encoded on the chip.

As discussed herein, secure document controls may aid in maintaining privacy of sensitive information. For instance, as discussed herein, the use of different ink and/or paper in printing a document or generating a photocopy of a document may enable use of the time, and legibility of the document, for a predetermined period of time. After the predetermined period of time lapses, the content of the printed document or generated photocopy may be obscured, erased, or the like, to ensure that control the sensitive information is maintained. Accordingly, if, for instance, a plurality of copies of a printed document or a plurality of generated photocopies are distributed at, for example, a meeting, the document or generated photocopy may be legible for the period of meeting and, after the time period lapses, the printed document or generated photocopy may no longer be legible, thereby maintaining control of the sensitive information contained in the document.

In some examples, additional authorization may be required to print a document or generate a copy of a document including sensitive information. For instance, if a user requests to print a document or copy a document, the system may determine that the document includes sensitive information. The system may then generate and transmit a notification to an authorizing user requesting authorization to complete the print or copy request. The authorizing user may then transmit a response to the system (e.g., via a user interface displayed on a user computing device) and the printing or copying may be completed (if authorized) or denied (if not authorized). Accordingly, control of how the document is printed may be performed based on whether authorization is received, rather than merely printing the document or not printing based on whether authorization is received.

In some instances, authorization from multiple users may be required prior to printing a document including sensitive information or generating a copy of a document including sensitive information. For instance, if a document includes sensitive information, a notification indicating that authorization to print or copy may be transmitted to a plurality of users. In some examples, at least a threshold number of the plurality of users must authorize printing or copying before the document will be printed or copied. For instance, a notification requesting authorization to print may be transmitted to five users. If at least three users authorize printing, the document may print. If fewer than three authorize printing, the print may be denied and a notification transmitted to the requesting user.

In some arrangements, two part ink may be used to further maintain security of the sensitive information in a document. For example, in some arrangements, responsive to determining that the document being printed or photocopied includes sensitive information, the system may select an ink source to use in printing the document or generating the photocopy. In some examples, the selected ink source may include two-part ink, including a first part formed of powdered ink and a second part formed of water. Upon determining that the document includes sensitive information, the two-part ink source may be selected for copying. Further, in order to enable distribution of each part of the ink to be mixed and used for printing, additional authorization may be required to release the first part of the ink and the second part of the ink to be mixed. For example, if a user requests a printed document that includes sensitive information, authorization to print the document may be required. In some examples, authorization may be required from two parties or authorizing users. Accordingly, a notification may be transmitted to each part and, upon receiving authorization from each party, a part of the ink may be released for mixing and the document may be printed or the photocopy may be generated. This may provide an additional level of control over the sensitive information within the document by requiring authorization by two individuals before the ink is available for use to print the document or generate the photocopy.

In some examples, if a user is not authorized to print a document including sensitive information, the document might not print. In other examples, it might print with the sensitive information redacted or otherwise obscured.

Additionally or alternatively, controlling an output destination of a printed document or generated photocopy may also aid in maintaining control of sensitive information. By outputting a printed document or generated photocopy to a secure document deposit box having controlled or limited access to only users authorized to access the box and contents thereof, the system may aid in controlling distribution of any sensitive information contained in the printed document or generated photocopy.

In some arrangements, users, such as customers of an entity, may be given special glasses or other viewing devices that permit a particular font to be viewed legibly through the glasses, while the font is not legible when viewed without the glasses or other viewing device. For example, upon opening an account, registering with a system, or the like, a customer may be given a viewing device unique to the user or particular to the user. Accordingly, documents may be generated using a font corresponding to the viewing device and legible when viewed through the viewing device.

In still other examples, documents may be printed to particular paper having a chip or other electronic device embedded therein which may read a fingerprint or other biometric data of a user to enable viewing of the document.

In some arrangements, the encoded paper may be used in conjunction with the glasses or viewing aid to enable functionality of the glasses. For instance, the electronic device in the paper may read a fingerprint or other identifying information from a user. The device may then transmit the information (and/or whether it matches pre-stored information) to a corresponding set of glasses for the authorized user. This may then enable the glasses to read the document.

In another example, the paper may include a token or cipher printed thereon. The glasses may include a corresponding token which may then enable viewing of the document.

The aspects described herein aid in maintaining control of sensitive information in printed documents and/or generated photocopies to avoid or eliminate unauthorized or unnecessary distribution of the document and/or information therein.

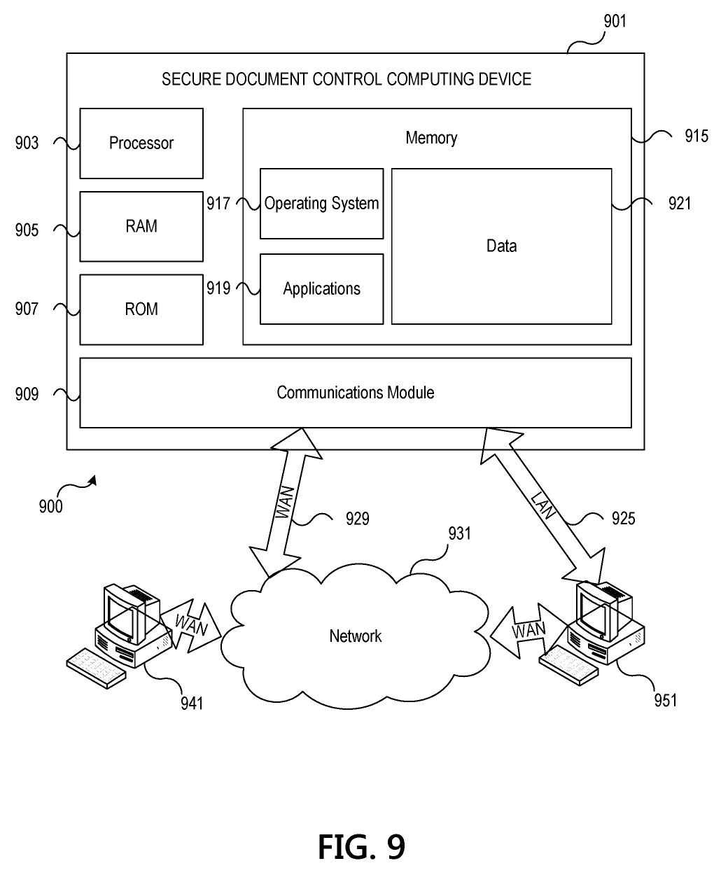

FIG. 9 depicts an illustrative operating environment in which various aspects of the present disclosure may be implemented in accordance with one or more example embodiments. Referring to FIG. 9, computing system environment 900 may be used according to one or more illustrative embodiments. Computing system environment 900 is only one example of a suitable computing environment and is not intended to suggest any limitation as to the scope of use or functionality contained in the disclosure. Computing system environment 900 should not be interpreted as having any dependency or requirement relating to any one or combination of components shown in illustrative computing system environment 900.

Computing system environment 900 may include secure document control computing device 901 having processor 903 for controlling overall operation of secure document control computing device 901 and its associated components, including Random Access Memory (RAM) 905, Read-Only Memory (ROM) 907, communications module 909, and memory 915. Secure document control computing device 901 may include a variety of computer readable media. Computer readable media may be any available media that may be accessed by secure document control computing device 901, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by computing device 901.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on secure document control computing device 901. Such a processor may execute computer-executable instructions stored on a computer-readable medium.

Software may be stored within memory 915 and/or storage to provide instructions to processor 903 for enabling secure document control computing device 901 to perform various functions. For example, memory 915 may store software used by secure document control computing device 901, such as operating system 917, application programs 919, and associated database 921. Also, some or all of the computer executable instructions for secure document control computing device 901 may be embodied in hardware or firmware. Although not shown, RAM 905 may include one or more applications representing the application data stored in RAM 905 while secure document control computing device 901 is on and corresponding software applications (e.g., software tasks) are running on secure document control computing device 901.

Communications module 909 may include a microphone, keypad, touch screen, and/or stylus through which a user of secure document control computing device 901 may provide input, and may also include one or more of a speaker for providing audio output and a video display device for providing textual, audiovisual and/or graphical output. Computing system environment 900 may also include optical scanners (not shown). Exemplary usages include scanning and converting paper documents, e.g., correspondence, receipts, and the like, to digital files.

Secure document control computing device 901 may operate in a networked environment supporting connections to one or more remote computing devices, such as computing devices 941 and 951. Computing devices 941 and 951 may be personal computing devices or servers that include any or all of the elements described above relative to secure document control computing device 901.

The network connections depicted in FIG. 9 may include Local Area Network (LAN) 625 and Wide Area Network (WAN) 629, as well as other networks. When used in a LAN networking environment, secure document control computing device 901 may be connected to LAN 925 through a network interface or adapter in communications module 909. When used in a WAN networking environment, secure document control computing device 901 may include a modem in communications module 909 or other means for establishing communications over WAN 929, such as network 931 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like and are configured to perform the functions described herein.

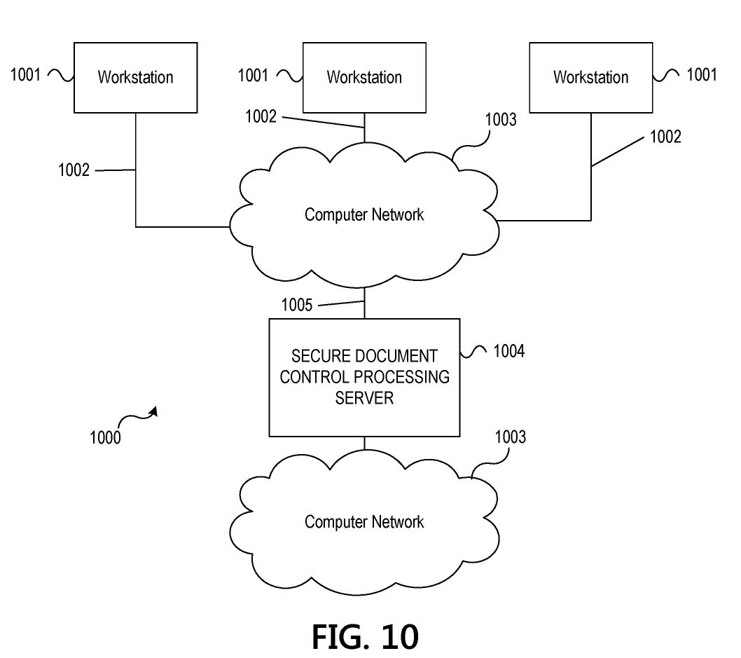

FIG. 10 depicts an illustrative block diagram of workstations and servers that may be used to implement the processes and functions of certain aspects of the present disclosure in accordance with one or more example embodiments. Referring to FIG. 10, illustrative system 1000 may be used for implementing example embodiments according to the present disclosure. As illustrated, system 1000 may include one or more workstation computers 1001. Workstation 1001 may be, for example, a desktop computer, a smartphone, a wireless device, a tablet computer, a laptop computer, and the like, configured to perform various processes described herein. Workstations 1001 may be local or remote, and may be connected by one of communications links 1002 to computer network 1003 that is linked via communications link 1005 to secure document control processing server 1004. In system 1000, secure document control processing server 1004 may be a server, processor, computer, or data processing device, or combination of the same, configured to perform the functions and/or processes described herein. Server 1004 may be used to continuously scan to detect requests for printing documents, photocopies of documents, and the like, evaluate the document to determine whether it includes sensitive information, identify an ink source, paper source, output destination, and the like, based on whether the document includes sensitive information, transmit commands to print the document or generate the photocopy based on control information, and the like.

Computer network 1003 may be any suitable computer network including the Internet, an intranet, a Wide-Area Network (WAN), a Local-Area Network (LAN), a wireless network, a Digital Subscriber Line (DSL) network, a frame relay network, an Asynchronous Transfer Mode network, a Virtual Private Network (VPN), or any combination of any of the same. Communications links 1002 and 1005 may be communications links suitable for communicating between workstations 1001 and secure document control nt processing server 1004, such as network links, dial-up links, wireless links, hard-wired links, as well as network types developed in the future, and the like.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A system, comprising:
a printing device having at least a first ink source and a second ink source, the second ink source including ink configured to fade after a predetermined time after contacting and reacting with air;
a computing device, including:
at least one processor;
a communication interface communicatively coupled to the at least one processor; and
memory storing computer-readable instructions that, when executed by the at least one processor, cause the computing device to:
receive a command to print a document;
evaluate characteristics of the document to determine whether the document includes sensitive information;
responsive to determining that the document does not include sensitive information, identify the first ink source for use in printing the document;
responsive to determining that the document includes sensitive information, identify the second ink source for use in printing the document; and
transmit a command to the printing device to print the document using the identified ink source.

2. The system of claim 1, wherein the second ink source includes ink having a different color than ink of the first ink source.

3. (canceled)

4. The system of claim 1, further including instructions that, when executed, cause the computing device to:
responsive to determining that the document does not include sensitive information, identify a first paper source for use in printing the document;
responsive to determining that the document includes sensitive information, identify a second paper source for use in printing the document; and
transmit a comment to the printing device to print the document using the identified paper source.

5. The system of claim 4, wherein the second paper source includes paper configured to obscure printing on the document a predetermined time period after printing the document.

6. The system of claim 4, wherein the second paper source includes paper configured to dissolve in water.

7. The system of claim 1, further including instructions that, when executed, cause the computing device to:
responsive to determining that the document does not include sensitive information, identify a first output destination for a printed document;
responsive to determining that the document includes sensitive information, identify a second output destination for the printed document, the second output destination being different from the first output destination; and
transmit a command to the printing device to print the document to the identified output destination.

8. The system of claim 7, wherein the second output destination is a secure document deposit box having controlled access.

9. The system of claim 1, wherein receiving the command to print the document further includes continuously scanning the printing device to detect commands to print the document.

10. A method, comprising:
at a computing platform comprising at least one processor, memory, and a communication interface:
receiving, by the at least one processor and via the communication interface, a command to print a document;
evaluating, by the at least one processor, characteristics of the document to determine whether the document includes sensitive information;
responsive to determining that the document does not include sensitive information, identifying, by the at least one processor, a first ink source for use in printing the document;
responsive to determining that the document includes sensitive information, identifying, by the at least one processor, a second ink source for use in printing the document the second ink source including ink configured to fade after a predetermined time after contacting and reacting with air; and
transmitting, by the at least one processor, a command to a printing device to print the document using the identified ink source.

11. The method of claim 10, wherein the second ink source includes ink having a different color than ink of the first ink source.

12. (canceled)

13. The method of claim 10, further including instructions that, when executed, cause the computing device to:
responsive to determining that the document does not include sensitive information, identifying, by the at least one processor, a first paper source for use in printing the document;
responsive to determining that the document includes sensitive information, identifying, by the at least one processor, a second paper source for use in printing the document; and
transmitting, by the at least one processor, a comment to the printing device to print the document using the identified paper source.

14. The method of claim 13, wherein the second paper source includes paper configured to obscure printing on the document a predetermined time period after printing the document.

15. The method of claim 13, wherein the second paper source includes paper configured to dissolve in water.

16. The method of claim 1, further including:
responsive to determining that the document does not include sensitive information, identifying, by the at least one processor, a first output destination for a printed document;
responsive to determining that the document includes sensitive information, identifying, by the at least one processor, a second output destination for the printed document, the second output destination being different from the first output destination; and
transmitting, by the at least one processor, a command to the printing device to print the document to the identified output destination.

17. The method of claim 16, wherein the second output destination is a secure document deposit box having controlled access.

18. The method of claim 10, wherein receiving the command to print the document further includes continuously scanning the printing device to detect commands to print the document.

19. One or more non-transitory computer-readable media storing instructions that, when executed by a computing platform comprising at least one processor, memory, and a communication interface, cause the computing platform to:
receive a command to print a document;
evaluate characteristics of the document to determine whether the document includes sensitive information;
responsive to determining that the document does not include sensitive information, identify a first ink source for use in printing the document;
responsive to determining that the document includes sensitive information, identify a second ink source for use in printing the document, the second ink source including ink configured to fade after a predetermined time after contacting and reacting with air; and
transmit a command to the printing device to print the document using the identified ink source.

20. The one or more non-transitory computer-readable media of claim 19, wherein the second ink source includes ink having a different color than ink of the first ink source.

21. (canceled)

22. The one or more non-transitory computer-readable media of claim 19, further including instructions that, when executed, cause the computing platform to:
responsive to determining that the document does not include sensitive information, identify a first paper source for use in printing the document;
responsive to determining that the document includes sensitive information, identify a second paper source for use in printing the document; and
transmit a comment to the printing device to print the document using the identified paper source.

23. The one or more non-transitory computer-readable media of claim 22, wherein the second paper source includes paper configured to obscure printing on the document a predetermined time period after printing the document.

24. The one or more non-transitory computer-readable media of claim 19, further including instructions that, when executed, cause the computing platform to:
responsive to determining that the document does not include sensitive information, identify a first output destination for a printed document;
responsive to determining that the document includes sensitive information, identify a second output destination for the printed document, the second output destination being different from the first output destination; and
transmit a command to the printing device to print the document to the identified output destination.

25. The one or more non-transitory computer-readable media of claim 24, wherein the second output destination is a secure document deposit box having controlled access.

26. The one or more non-transitory computer-readable media of claim 19, wherein receiving the command to print the document further includes continuously scanning the printing device to detect commands to print the document.
